(19) United States
(12) Patent Application Publication
(10) Pub. No.: US 2009/0135116 A1
(43) Pub. Date: May 28, 2009

(54) GAMMA REFERENCE VOLTAGE GENERATING DEVICE AND GAMMA VOLTAGE GENERATING DEVICE

(75) Inventor: Yaw-Guang Chang, Tainan County (TW)

Correspondence Address: J C PATENTS, INC., 4 VENTURE, SUITE 250, IRVINE, CA, 92618, US

(73) Assignee: HIMAX TECHNOLOGIES LIMITED, Tainan County (TW)

(21) Appl. No.: 12/115,705

(22) Filed: May 6, 2008

Related U.S. Application Data
(60) Provisional application No. 60/989,845, filed on Nov. 23, 2007.

(51) Int. Cl. G09G 3/36

(52) U.S. Cl. 345/87

(57) ABSTRACT

A gamma reference voltage generating device and a gamma voltage generating device are provided herein. The gamma reference voltage generating device includes a reference voltage source and a selector. The reference voltage source has a first terminal and a second terminal respectively coupled to a first adjustable voltage and a second adjustable voltage for providing a plurality of reference voltages. The selector selectively outputs one of the reference voltages as a gamma reference voltage according to a selecting signal. By regulating the first and the second adjustable voltage, the range of the reference voltages provided by the reference voltage source can be adjusted so as to adjust the gamma reference voltage and the outputted voltage resolution.

### CROSS-REFERENCE TO RELATED APPLICATION

This application claims the priority benefit of U.S.A. provisional application Ser. No. 60/989,845, filed on Nov. 23, 2007, all disclosures are incorporated therewith.

### BACKGROUND OF THE INVENTION

1. Field of Invention

The present invention relates to a gamma reference voltage generating device and a gamma voltage generating device, and more particularly, to the devices that adjust the reference voltage range for adjusting the gamma reference voltage and the gamma voltage.

2. Description of the Related Art

With great advance in the techniques of electro-optical and semiconductor devices, flat panel displays, such as liquid crystal displays (LCD), have enjoyed burgeoning development and flourished in recent year. Due to the numerous advantages of the LCD, such as low power consumption, free of radiation, and high space utilization, the LCD has become the main stream in the market.

FIG. 1 is a diagram of a conventional gamma voltage generating device. Referring to FIG. 1, in the LCD structure, there is an additional gamma voltage generating device 110 disposed outside of the source driver 120 to generate a plurality of gamma voltages Vgma_1 through Vgma_M to the source driver 120. In the gamma voltage generating device 110, a reference voltage source 111 includes a plurality of series-connected resistors 111a for providing a plurality of reference voltages Vr_1 through Vr_N according to the reference ladder resistance, wherein M≧N. Because of the process limitation, the reference voltage source 111 may not generate a sufficient number of different reference voltages Vr_1 through Vr_N as the gamma voltages Vgma_1 through Vgma_M for displaying fine variation of image gray-scale values. As a result, each of the reference voltages Vr_1 through Vr_N is referred to generate the gamma voltages Vgma_1 through Vgma_M by the fine trimming resistor 112.

Generally, the nodes A and B of the reference voltage source 111 are respectively fixed coupled to a (positive or negative) power voltage VDD and a ground voltage GND, and the reference voltage range is between the power voltage VDD and the ground voltage GND. In such way, single ideal gamma curve, e.g. gamma value γ=2.5, is referred to design the reference ladder resistance of the series-connected resistors 111a and the resistors 111a are soldered on the printed circuit board (PCB) so that the provided gamma voltages are not adjustable and the voltage resolution is fixed. If polarity inversion is employed on the LCD for eliminating DC residual voltage stored in liquid crystal layer, two gamma voltage generating devices 110 are needed to provide the gamma voltages with different polarities to the source driver 120, wherein the node A of one gamma voltage generating device 110 is coupled to the positive power voltage and the node A of the other gamma voltage generating device 110 is coupled to the negative power voltage.

Next, the source driver 120 generates a plurality of driving voltages corresponding to different gray-scale data in accordance with the said gamma voltages Vgma_1 through Vgma_M and the source driver 120 provides the driving voltages to the pixel electrode for displaying pixel image. Generally, the driving voltage provided to the pixel electrode is not usually as good as expected because of feed through effect so that the common voltage coupled to the liquid crystal layer needs to be adjusted to compensate the panel feed through effect and avoid flickers. However, an additional circuit for adjusting the common voltage may occupy layout area and the operation of such circuit also causes power dissipation.

### SUMMARY OF THE INVENTION

The present invention provides a gamma reference voltage generating device and a gamma voltage generating device that adjust the gamma voltage to improve the panel feed through problem and avoid the flickers without additional amplifying circuit of common voltage or without dissipating too much power if the amplifying circuit of common voltage existed.

The gamma reference voltage generating device is provided in the present invention. The gamma reference voltage generating device includes a reference voltage source and a selector. The reference voltage source has a first terminal and a second terminal respectively coupled to a first adjustable voltage and a second adjustable voltage. The reference voltage source is used for providing a plurality of reference voltages. The selector selectively outputs one of the reference voltages as a gamma reference voltage according to a selecting signal.

The gamma voltage generating device adapted to a display device is provided in the present invention. The gamma voltage generating device includes a gamma reference voltage generating device and a converting module, wherein the gamma reference voltage generating device includes a reference voltage source and a selector. The reference voltage source has a first terminal and a second terminal respectively coupled to a first adjustable voltage and a second adjustable voltage, and the reference voltage source provides a plurality of reference voltages. The selector selectively outputs one of the reference voltages as a gamma reference voltage according to a selecting signal. The converting module generates a plurality of gamma voltages according to the gamma reference voltage, and the gamma voltages correspond to different gray-scale data respectively.

In the foregoing gamma reference voltage generating device and the gamma voltage generating device, the reference voltage source includes a plurality of first resistors and a variable resistor. The first resistors are series connected and the first resistors provide the said reference voltages respectively according to a reference ladder resistance. The variable resistor is series coupled to the first resistors and is used for adjusting a voltage range between the variable resistor and the first terminal of the reference voltage source and a voltage range between the variable resistor and the second terminal of the reference voltage source according to a control signal.

The present invention provides the gamma reference voltage generating device and the gamma voltage generating device that can adaptively adjusts the two terminal voltages of the reference voltage source so as to adjust the gamma reference voltages and the gamma voltages. Besides, the said variable resistor can also adjust the voltage range between the variable resistor and the first terminal of the reference voltage source and the voltage range between the variable resistor and the second terminal of the reference voltage source. As a result, adjusting the gamma voltages provided to the pixel electrode can improve the problem of panel feed through and avoid the flickers without amplifying the common voltage, and therefore the power consumption can be reduced and additional amplifying circuit may not be needed for saving layout area. Furthermore, the voltage resolution can be adapted to the image content since the voltage range of the reference voltage is adjustable.

In order to make the features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a conventional gamma voltage generating device.

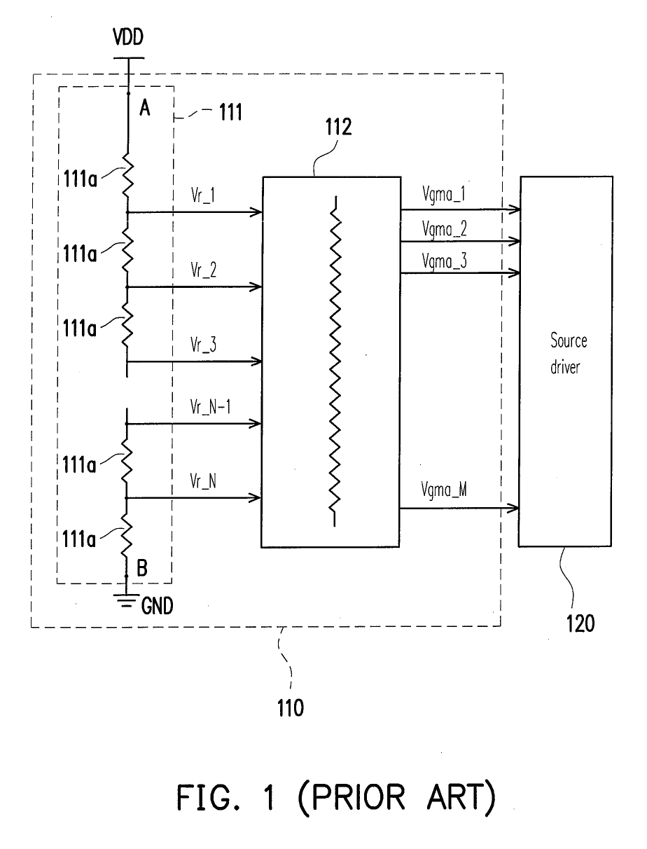

FIG. 2 is a circuit diagram of gamma reference voltage generating device according to an embodiment of the present invention.

FIG. 3A, FIG. 3B and FIG. 3C are circuit diagrams of generating a second reference voltage, the first adjustable voltage and the second adjustable voltage respectively according to an embodiment of the present invention.

FIG. 4 is a circuit diagram of the gamma voltage generating device according to an embodiment of the present invention.

FIG. 5 is a circuit diagram of the gamma voltage generating device according to another embodiment of the present invention.

### DESCRIPTION OF THE EMBODIMENTS

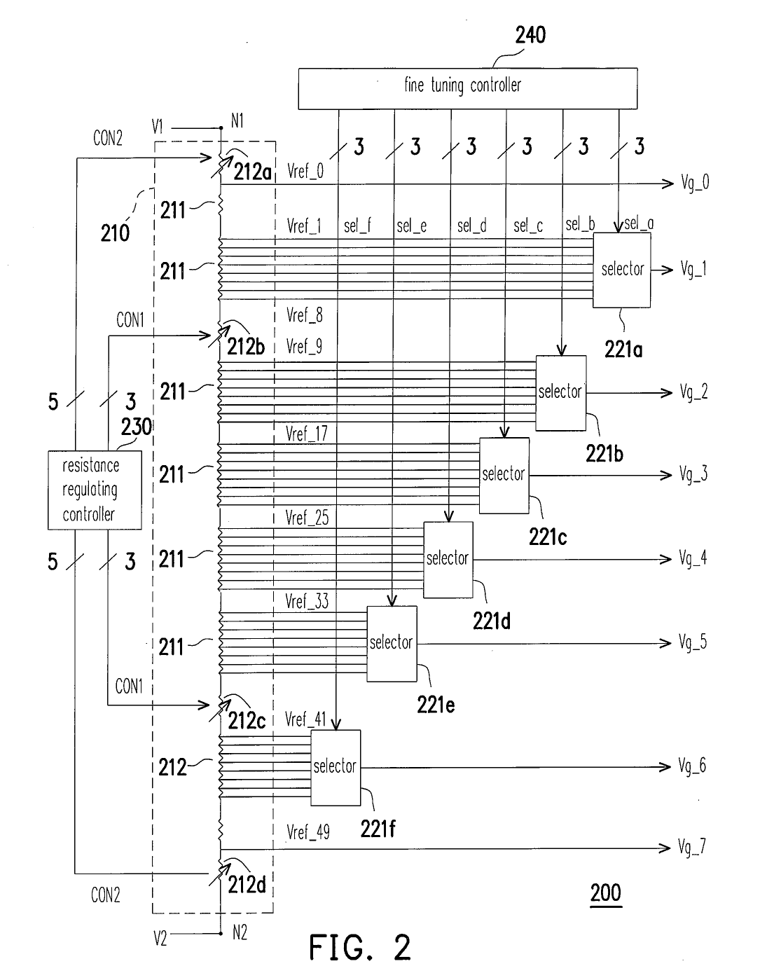

As known, the liquid crystal has non-linear light transmission with respect to a pixel voltage, which is directly converted from a gray-scale data of the image, so that a gamma correction should be employed on the pixel voltage. A gamma voltage generating device is needed for generating a gamma voltage related to a gray-scale data of the image for controlling a rotation angle and light transmission of the liquid crystal when displaying an image. FIG. 2 is a circuit diagram of gamma reference voltage generating device according to an embodiment of the present invention. It is assumed that the gamma reference voltage generating device 200 of the embodiment is applied to display devices, such as liquid crystal display (LCD) and liquid crystal on silicon (LCOS) display panel.

Referring to FIG. 2, the gamma reference voltage generating device 200 includes a reference voltage source 210, the selectors 221a through 221f, a resistance regulating controller 230 and a fine tuning controller 240. The reference voltage source 210 includes a plurality of resistors 211 and the variable resistors 212a through 212d, and those said resistors are series connected mutually. The reference voltage source 210 has a first terminal N1 and a second terminal N2 respectively coupled to a first adjustable voltage V1 and a second adjustable voltage V2. The first adjustable voltage V1 and the second adjustable voltage V2 can be set by registers in the embodiment. The series-connected resistors 211 provide a plurality of reference voltages Vref_0 through Vref_49 according to the reference ladder resistance. Each of the variable resistors 212a through 212d adjust the voltage range between itself and the first terminal N1 of the reference voltage source 210 and the voltage range between itself and the second terminal N2 of the reference voltage source 210 according to the corresponding control signal CON1 or CON2 so as to adjust the reference voltages Vref_0 through Vref_49. The resistance regulating controller 230 is used for providing the control signal CON1 to trim the variable resistors 212b and 212c and providing the control signal CON2 to trim the variable resistors 212a and 212d.

For example, suppose that the first adjustable voltage V1 and the second adjustable voltage V2 are positive voltages, e.g. 5 volt and 1 volt respectively, for providing the reference voltages Vref_0 through Vref_49 with positive polarity to the source driver (not illustrated). In this assumption, the voltage range between the first terminal N1 and the second terminal N2 of the reference voltage source 210 is 4 volt. Hence, the voltage range between the variable resistor 212b and the first terminal N1 of the reference voltage source 210 can be adjusted from 0 volt to 4 volt by the resistor 212b. Referring to FIG. 2, the voltage range between the variable resistor 212b and the first terminal N1 of the reference voltage source 210 is utilized to generate the reference voltages Vref_0 through Vref_8 so that the smaller the said voltage range is, the higher the voltage resolution of the reference voltage is.

Next, referring to FIG. 2, it is assumed that each selector is 8-to-1 selector and each selector selectively outputs one of eight reference voltages as a gamma reference voltage according to the corresponding selecting signal, wherein the selecting signals sel_a through sel_f are provided by the fine tuning controller 240. Take the selector 221a as an example. The selector 221a selectively outputs one of the reference voltages Vref_1 through Vref_8 as the gamma reference voltage Vg_1 according to the selecting signal sel_a. In the embodiment, the gamma reference voltages Vg_0 through Vg_7 can be adaptively adjusted since the first adjustable voltage V1 and the second adjustable voltage V2 can be set by registers, which are storages for storing the values of the first and the second adjustable voltages V1 and V2, for changing the voltage range between the first terminal N1 and the second terminal N2. Besides, a fine tuning function is implemented by the variable resistors 212a through 212d included in the reference voltage source 210 so as to obtain the needed gamma curve.

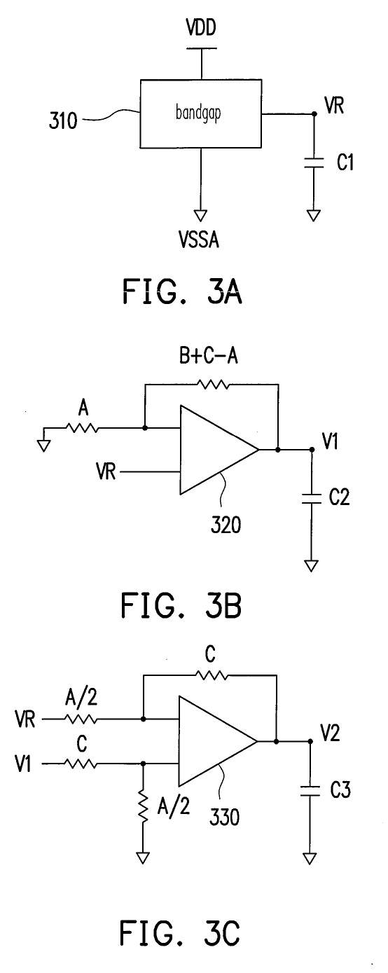

In order to make people ordinary skilled in the art easy to practice the said embodiment, the following describes how to generate the first adjustable voltage V1 and the second adjustable voltage V2 with positive polarity. FIG. 3A is a circuit diagram of generating a second reference voltage, which is referred to generate the said adjustable voltages according to an embodiment of the present invention. FIG. 3B and FIG. 3C are circuit diagrams of generating the first adjustable voltage and the second adjustable voltage respectively according to an embodiment of the present invention. Referring to FIG. 3A, the bandgap 310 is a simple circuit for generating a second reference voltage VR about 1.8 volt, and the provided second reference voltage VR may not be influenced by the temperature and the power supply nearly. Referring to FIG. 3B, the operational amplifier 320 has a first input terminal coupled to a resistor with resistance A, a second input terminal coupled to the second reference voltage VR, and an output terminal coupled to the first input terminal thereof via a resistor with resistance (B+C−A). Therefore, the first adjustable voltage V1 equals (B/A+C/A)×VR. Referring to FIG. 3C, the operation amplifier 330 has a first input terminal coupled to the second reference voltage VR via a resistor with resistance (A/2), a second input terminal coupled to a resistor with resistance (A/2) and coupled to the first adjustable voltage V1 via a resistor with resistance C, and an output terminal coupled to the first input terminal thereof via a resistor with resistance C. Hence, the second adjustable voltage V2 equals to (B/A−C/A)×VR.

Although the said embodiment supposes that the first adjustable voltage V1 and the second adjustable voltage V2 are positive voltages for providing the reference voltages with positive polarity, the first adjustable voltage V1 and the second adjustable voltage V2 also can be set to negative voltages for providing the reference voltages with negative polarity in another embodiment. Certainly, the negative voltages of the first adjustable voltage V1 and the second adjustable voltage V2 can be generated according to the teaching of the embodiments in FIG. 3A through FIG. 3C. In addition, the gamma reference voltage generating device 200 can be disposed on the source driver for providing the gamma voltages, which correspond to different gray-scale data, to the pixel electrode.

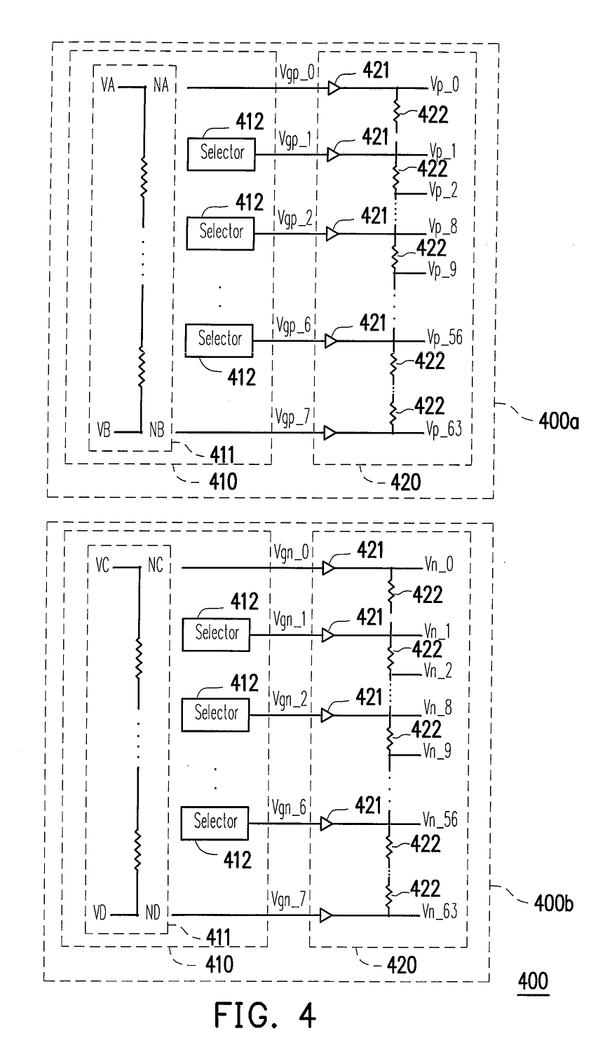

FIG. 4 is a circuit diagram of the gamma voltage generating device according to an embodiment of the present invention. Referring to FIG. 4, the gamma voltage generating device 400 includes a first gamma voltage generating device 400a and a second gamma voltage generating device 400b. Each of the first and the second gamma voltage generating devices 400a and 400b includes a gamma reference voltage generating device 410 and a converting module 420. The gamma reference voltage generating devices 410 can be implemented by the said gamma voltage generating device 200 in FIG. 2 and some elements, such as resistance regulating controller and fine tuning controller are not illustrated in FIG. 4. In the embodiment, two terminals NA and NB of the reference voltage source 411 in the first gamma voltage generating device 400a are coupled to positive adjustable voltages VA and VB for generating the gamma reference voltages Vgp_0 through Vgp_7 with positive polarity. Besides, two terminals NC and ND of the reference voltage source 411 in the second gamma voltage generating device 400b are coupled to negative adjustable voltages VC and VD for generating the gamma reference voltage Vgn_0 through Vgn_7 with negative polarity.

Take the first gamma voltage generating device 400a as an example. The converting module 420 includes a plurality of resistors 422 and a plurality of buffers 421, wherein the resistors 422 are series connected. As the foregoing description, each of the selectors 412 chooses one of the reference voltages generated by reference voltage source 411 as the gamma reference voltage, e.g. Vgp_0, Vgp_1, . . . Vgp_7. The series-connected resistors 422 have some nodes coupled to the gamma reference voltages Vgp_0 through Vgp_7 via the corresponding buffers 421 for generating a plurality of gamma voltages Vp_0 through Vp_63 according to the voltage division principle, wherein the buffers 421 is used for enhancing signal transmission intensity. Hence, the gamma voltages Vp_0 through Vp_63 with positive polarity, which correspond to different gray-scale data of the image, are obtained. To reason by analogy, in the second gamma voltage generating device 400b, the converting module 420 generates the gamma voltages Vn_0 through Vn_63 with negative polarity according to the gamma reference voltages Vgn_0 through Vgn_7.

It is noted that in the first and the second gamma voltage generating devices 400a and 400b, regulating two terminal voltages of the reference voltage source 411 can adjust the voltage range of the reference voltage source 411 so as to adjust the gamma voltages. Not only can generate the gamma voltages conforming to the needed gamma curve, but also can improve the panel feed through problem and avoid flickers by providing the adjusted gamma voltages. Consequently, an additional amplifying circuit of the common voltage is not needed in the embodiment as compared with the prior art for saving power and reducing the layout area.

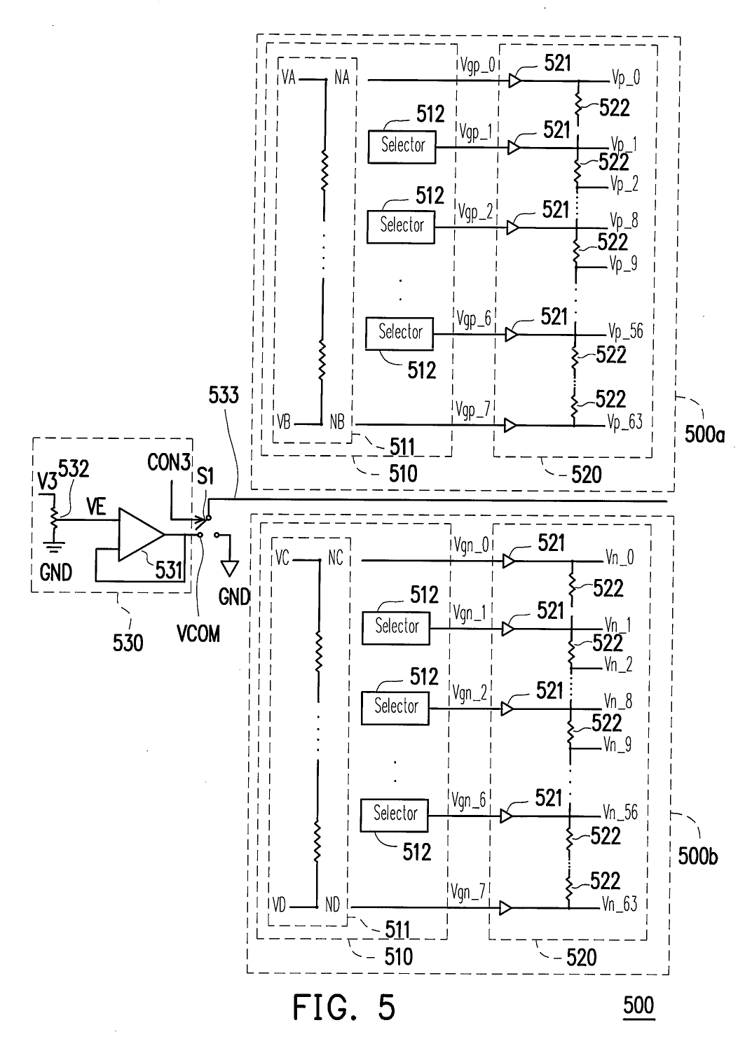

Nowadays, most circuit designs of display device still include the amplifying circuit of the common voltage so that the amplifying circuit should be turned off if the gamma voltages are adjusted by the said embodiment for saving power. FIG. 5 is a circuit diagram of the gamma voltage generating device according to another embodiment of the present invention. Referring to FIG. 4 and FIG. 5, the difference between the embodiments in FIG. 4 and FIG. 5 is that the gamma voltage generating device 500 further includes a common voltage generator 530 and a switch S1 for selectively connecting an adjusted common voltage VCOM or a ground voltage GND to a common electrode 533. The common voltage generator 530 includes a voltage buffer 531 and a series resistor 532.

The series resistor 532 is coupled between a third adjustable voltage V3 and a ground voltage GND for providing a voltage VE to the voltage buffer 531, wherein the voltage range of the series resistor 532 is controlled by the third adjustable voltage V3. The voltage buffer 531 has a first input terminal coupled to the voltage VE, a second input terminal coupled to an output terminal thereof, namely a voltage follower. The switch S1 is coupled to the common electrode 533, wherein the conductivity of the switch S1 is controlled by a switching control signal CON3. The switch S1 selectively switches the common electrode 533 to the output terminal of the voltage buffer 531 for delivering the adjusted common voltage VCOM to the common electrode 533 or switches the common electrode 533 to the ground voltage GND for saving power. Simply speaking, if the common voltage needs to be adjusted for compensating the panel feed through effect, the voltage buffer 531 can generate the adjusted common voltage VCOM by regulating the third adjustable voltage V3 and then deliver the adjusted common voltage VCOM to the common electrode 533 via the switch S1. Besides, if the gamma voltages are adjusted by the first and the second gamma voltage generating devices 500a and 500b, the common electrode 533 is electrically connected to the ground voltage GND for saving power.

In summary, the said embodiment set two terminal voltages of the reference voltage source to be positive voltages or negative voltages for providing the gamma voltage with needed polarity (i.e. positive polarity or negative polarity). In addition, the gamma curve should be adapted to different characteristics of display device and/or adapted to image content so that the needed gamma curve can be obtained by adjusting the voltage range between two terminals of the reference voltage source or fine tuning the variable resistor included in the reference voltage source. By the way, the said embodiments can also adjust the gamma voltages provided to the source driver so as to improve the panel feed through problem and avoid flickers without additional amplify circuit of the common voltage for saving power and layout area.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A gamma reference voltage generating device, comprising:
a reference voltage source, providing a plurality of reference voltages, wherein the reference voltage source has a first terminal coupled to a first adjustable voltage and a second terminal coupled to a second adjustable voltage; and
a selector, selectively outputting one of the reference voltages as a gamma reference voltage according to a selecting signal.

2. The gamma reference voltage generating device as claimed in claim 1, wherein the reference voltage source comprises:
a plurality of first resistors, coupled in series for providing the reference voltages respectively according to a reference ladder resistance; and
a variable resistor, coupled to the first resistors in series for adjusting a voltage range between the variable resistor and the first terminal of the reference voltage source and a voltage range between the variable resistor and the second terminal of the reference voltage source according to a control signal.

3. The gamma reference voltage generating device as claimed in claim 2, further comprising:
a resistance regulating controller, providing the control signal.

4. The gamma reference voltage generating device as claimed in claim 1, further comprising:
a fine tuning controller, providing the selecting signal.

5. The gamma reference voltage generating device as claimed in claim 1, wherein the first adjustable voltage and the second adjustable voltage are positive voltages.

6. The gamma reference voltage generating device as claimed in claim 1, wherein the first adjustable voltage and the second adjustable voltage are negative voltages.

7. A gamma voltage generating device adapted to a display device, comprising:
a gamma reference voltage generating device, comprising:
a reference voltage source, providing a plurality of reference voltages, wherein the reference voltage source has a first terminal coupled to a first adjustable voltage and a second terminal coupled to a second adjustable voltage; and
a selector, selectively outputting one of the reference voltages as a gamma reference voltage according to a selecting signal; and
a converting module, generating a plurality of gamma voltages according to the gamma reference voltage, wherein the gamma voltages correspond to different gray-scale data respectively.

8. The gamma voltage generating device as claimed in claim 7, wherein the reference voltage source comprises:
a plurality of first resistors, coupled in series for providing the reference voltages; and
a variable resistor, coupled to the first resistors in series for adjusting a voltage range between the variable resistor and the first terminal of the reference voltage source and a voltage range between the variable resistor and the second terminal of the reference voltage source according to a control signal.

9. The gamma voltage generating device as claimed in claim 8, wherein the gamma reference voltage generating device further comprises:
a resistance regulating controller, providing the control signal.

10. The gamma voltage generating device as claimed in claim 7, wherein the gamma reference voltage generating device further comprises:
a fine tuning controller, providing the selecting signal.

11. The gamma voltage generating device as claimed in claim 7, wherein the converting module comprises:
a plurality of second resistors, coupled in series for providing the gamma voltages according to the gamma reference voltage.

12. The gamma voltage generating device as claimed in claim 11, wherein the converting module further comprises:
a buffer, coupled between the selector and the second resistors for enhancing a signal transmission intensity.

13. The gamma voltage generating device as claimed in claim 7, wherein the first adjustable voltage and the second adjustable voltage are positive voltages.

14. The gamma voltage generating device as claimed in claim 7, wherein the first adjustable voltage and the second adjustable voltage are negative voltages.

15. A gamma voltage generating device adapted to a display device, comprising:
a first gamma voltage generating device and a second gamma voltage generating device, respectively comprising:
a gamma reference voltage generating device, comprising:
a reference voltage source, providing a plurality of reference voltages, wherein the reference voltage source has a first terminal coupled to a first adjustable voltage and a second terminal coupled to a second adjustable voltage; and
a selector, selectively outputting one of the reference voltages as a gamma reference voltage according to a selecting signal; and
a converting module, generating a plurality of gamma voltages according to the gamma reference voltage, wherein the gamma voltages correspond to different gray-scale data respectively.

16. The gamma voltage generating device as claimed in claim 15, further comprising:
a common voltage generator, providing an adjusted common voltage to a common electrode, and comprising:
a voltage buffer, having a first input terminal coupled to a first voltage, a second input terminal, and an output terminal, wherein the second input terminal and the output terminal are coupled together; and
a series resistor, coupled between a third adjustable voltage and a ground voltage for providing the first voltage to the first input terminal of the voltage buffer, wherein a voltage range of the series resistor is controlled by the third adjustable voltage; and
a switch, coupled to the common electrode for selectively switching the common electrode to the out terminal of the voltage buffer or to the ground voltage according to a switching control signal.

17. The gamma voltage generating device as claimed in claim 15, wherein the reference voltage source comprises:
a plurality of first resistors, coupled in series for providing the reference voltages; and
a variable resistor, coupled to the first resistors in series for adjusting a voltage range between the variable resistor and the first terminal of the reference voltage source and a voltage range between the variable resistor and the second terminal of the reference voltage source according to a control signal.

18. The gamma voltage generating device as claimed in claim 17, wherein the gamma reference voltage generating device comprises:
a resistance regulating controller, providing the control signal.

19. The gamma voltage generating device as claimed in claim 15, wherein the gamma reference voltage generating device comprises:
a fine tuning controller, providing the selecting signal.

20. The gamma voltage generating device as claimed in claim 15, wherein the converting module comprises:
a plurality of second resistors, coupled in series for providing the gamma voltages according to the gamma reference voltage.

21. The gamma voltage generating device as claimed in claim 20, wherein the converting module further comprises:
a buffer, coupled between the selector and the second resistors for enhancing a signal transmission intensity.

22. The gamma voltage generating device as claimed in claim 15, wherein the first adjustable voltage and the second adjustable voltage in the first gamma voltage generating device are positive voltages, and the first adjustable voltage and the second adjustable voltage in the second gamma voltage generating device are negative voltages.
